(19) United States
(12) Patent Application Publication
(10) Pub. No.: US 2024/0382932 A1
(43) Pub. Date: Nov. 21, 2024

(54) TRANSIENTLY POROUS CRYOGEL COMPOSITE STRUCTURES FOR FAST CARBON DIOXIDE CAPTURE FROM AIR FOR USEFUL CHEMICAL PRODUCTS

(71) Applicant: UNIVERSITY OF SOUTH FLORIDA, Tampa, FL (US)

(72) Inventors: Nurettin Sahiner, Tampa, FL (US); Manoj Kumar Ram, Tampa, FL (US)

(21) Appl. No.: 18/667,691

(22) Filed: May 17, 2024

Related U.S. Application Data
(60) Provisional application No. 63/502,833, filed on May 17, 2023.

(51) Int. Cl. B01J 20/26; B01D 53/04; B01J 20/20; B01J 20/22; B01J 20/28; B01J 31/16; C08J 3/24

(52) U.S. Cl. CPC B01J 20/262; B01D 53/04; B01J 20/205; B01J 20/226; B01J 20/28047; B01J 20/28085; B01J 31/1691; C08J 3/24; B01D 2253/202; B01D 2253/308; B01D 2257/504; C08J 2379/02

(57) ABSTRACT

A superporous material comprises: a crosslinked linear polyethyleneimine (PEI) microgel comprising the reaction product of linear polyethyleneimine and a crosslinker; an embedded body; and amine functional groups, wherein the embedded body and amine functional groups are available for CO₂ association. There is disclosed a method of removing CO₂ from a fluidic waste stream, wherein the method comprises contacting the waste stream with the superporous material, wherein the CO₂ from the fluidic waste stream bonds to an amine functional group in the superporous material. There is also disclosed a method of removing CO₂ from a fluidic waste stream, wherein the method comprises contacting the waste stream with the catalytic superporous material and a flowing gas, and converting CO₂ to at least one of methanol, ethanol, carbonic acid, and methane.

### CROSS-REFERENCE TO RELATED APPLICATIONS

The present application is based on, claims priority to, and incorporates herein by reference in its entirety for all purposes, U.S. Patent Application No. 63/502,833 filed May 17, 2023.

### STATEMENT REGARDING FEDERALLY SPONSORED RESEARCH

Not applicable.

### REFERENCE TO A SEQUENCE LISTING

Not applicable.

### FIELD OF THE INVENTION

The disclosed technology is generally directed to superporous materials. More particularly the technology is directed to the use of superporous materials to capture CO₂.

### BACKGROUND

The biggest problem of the twenty-first century is global warming and the consequences of are now noticeably affecting human health and the ecosystem seriously. Before the industrial revolution, Earth's temperature was increasing as a consequence of natural activities such as volcano eruption, tectonic irregularity, and uncontrollable events [Ref. 1-3]. Recently, anthropogenic and industrial activities have caused an enormous increase in temperature and emission of several greenhouse gases (GHG) e.g., water vapor, CO₂, CH₄, and N₂O [Ref. 1-4]. Global warming because of the emissions of greenhouse gases is affecting human life adversely causing irreversible challenges in the environment and atmosphere, therefore many countries trying to cope with this issue by adopting new regulations and policies to reduce greenhouse gas emissions. The most dangerous anthropogenic greenhouse gas on the planet causing global warming is CO₂ [Ref. 5-7]. It was reported that due to cumulative carbon dioxide (CO₂) emissions in the atmosphere, a 1.5° C. increase in global temperature (the limit where the harmful effects of climate change will be most evident) is predicted between 2032 and 2050 [Ref. 8-10].

The concerns about global climate change has intensified the efforts to control, reduce or even reduce greenhouse gas emissions to zero [Ref. 5-10]. Today, about 80% of the energy used in the world is provided by power plants working with fossil fuels, which cause approximately 40% of total CO₂ emissions [Ref. 11-13]. As the level of atmospheric CO₂ concentration was 280 ppm in the early 1750s, it continues to increase alarmingly, increasing to 420 ppm in 2021 [Ref. 11-13]. Therefore, fossil fuel-burning power plants become the most logical targets for controlling CO₂ emissions [Ref. 8-14]. Various options exist to reduce CO₂ emissions, such as demand-side protection, supply-side efficiency improvement, increasing reliance on nuclear and renewable energy, and CO₂ capture and storage (CCS) systems [Ref. 15-17]. However, it is thought that fossil fuels will continue to be used as a primary energy source soon, since the processes of transition to renewable energy sources are costly. Therefore, carbon capture and storage is the most practical approach, standing out as the most important technology for controlling the CO₂ concentration in the atmosphere [Ref. 8, 9, 15]. Basically, CO₂ capture, and storage technology covers the processes of capturing CO₂ at the point of manufacture, compressing and separating the captured CO₂ storing in different forms [Ref. 18-20]. The CO₂ capture and storage processes are the most costly part of the total process [Ref. 21]. Also, the transport of captured CO₂, burden hugely to the overall cost of CO₂ necessitating energy intensive and expensive support infrastructure. The CO₂ capture, purification, compression, transport, and regeneration of the capture medium are a colossal burden to the overall carbon economy [Ref. 22].

Therefore, there is an urgent need to directly capture the CO₂ from air and convert to commercial products directly to curb the carbon footprint of the chemical industry. The production of carbon containing chemicals are the substantial contributors of CO₂ emissions into the atmosphere. To eliminate or attain carbon negative commodity chemical, the produced CO₂ needs to be captured at point of production and converted to commercial products directly.

### SUMMARY

The present disclosure addresses the foregoing needs by providing a superporous material that can capture CO₂ from liquid or gaseous waste streams when the waste stream flows through the superporous material. The superporous material may contain one or more embedded bodies that associate with CO₂. The embedded bodies may allow chemical reactions with CO₂ or facilitate catalytic reactions of CO₂ with gases to produce carbonic acid, methanol, or ethanol.

The embodiments of the present disclosure provide for a superporous material including a crosslinked linear polyethyleneimine (PEI) microgel comprising the reaction product of linear polyethyleneimine and a crosslinker, an embedded body, and amine functional groups, where the embedded body and amine functional groups are available for CO₂ association. In one embodiment, the crosslinker is selected from the group consisting of divinyl sulfone, glycerol diglycidyl ether, phosphonitrillic chloride and tetrakis hydroxyphosphonium chloride. In another embodiment, the embedded body includes a PEI microgel, a PEI nanogel, a PEI cryogel, or a combination thereof. In a further embodiment the PEI cryogel is a crosslinked PEI cryogel.

In some embodiments, the embedded body includes at least one of: a framework material selected from the group consisting of a metal organic framework (MOF), a covalent organic framework (COF), a zeolitic imidazolate framework, or a combination thereof, a carbon material selected from the group consisting of porous carbon particles, carbon black, single-walled carbon nanotubes, multiwalled carbon nanotubes, PEI-modified carbon nanotubes, graphene, graphene oxide, reduced graphene oxide, and any combination thereof, a metal ion selected from the group consisting of calcium ions, magnesium ions, and aluminum ions, and any combination thereof, a clay selected from the group consisting of kaolin, bentonite, montmorillonite, halloysite nanotubes, and any combination thereof, a silicate particle, or a MXene or a modified MXenc.

In some embodiments, the embedded body further includes at least one amine functional group. In further embodiments, the embedded body includes an amine-based COF that is one of triethylenetetramine (TETA), pentaethylenchexamine (PEHA), or PEI crosslinked with PNC. In still further embodiments, the embedded body comprises Mg-MOF74.

Certain embodiments of the present disclosure provide for a method of forming a superporous material. The method includes preparing a solution of PEI and an embedded body to form a mixture, freezing the mixture, thawing the mixture to room temperature, and freeze-drying the mixture to form the superporous material as a cryogel. In some embodiments, the method includes heating the solution of PEI prior to adding a crosslinker to the solution of PEI to form the mixture. In some embodiments, the mixture is frozen and kept between −18° C. and −20° C. for between 12 hours and 48 hours. In other embodiments, the solution of PEI is heated at 100° C. and the mixture is cooled at −20° C. for 24 hours.

Certain embodiments of the present disclosure provide for a method of preparing a catalytic superporous material. In some embodiments the method includes (i) providing the superporous material of claim 1, wherein the embedded body acts as a template for forming a metal catalyst, (ii) loading the superporous material with metal ions by immersion of the superporous material in at least one metal ion solution, and (iii) treating the loaded superporous material from step (ii) with aqueous NaBH₄ solution to reduce the metal ions to form a metal catalyst particle embedded within the catalytic superporous material. In some embodiments, the embedded body is a metal organic framework or a covalent organic framework. In other embodiments, the metal ions are selected from the group consisting of Cu(II), Ru(III), Co(II), Ni(II), and combinations thereof. In still further embodiments, steps (ii) and (iii) are repeated using solutions of the same or different metal ions.

Some embodiments of the present disclosure provide for a method of removing CO₂ from a fluidic waste stream. Some embodiments include contacting the waste stream, with the superporous material of claim 1, where the CO₂ from the fluidic waste stream bonds to an amine functional group in the superporous material. In some embodiments, the superporous material is treated with a base prior to contacting the waste stream. In other embodiments, the method of removing CO₂ from a fluidic waste stream includes contacting the waste stream with the catalytic superporous material of claim 1 and a flowing gas. In further embodiments, the embedded body is a metal nanoparticle, and the superporous material converts CO₂ to at least one of methanol, ethanol, carbonic acid, and methane.

The foregoing and other aspects and advantages of the invention will appear from the following description. In the description, reference is made to the accompanying drawings which form a part hereof, and in which there is shown by way of illustration example embodiments of the invention. Such embodiments do not necessarily represent the full scope of the invention, however, and reference is made therefore to the claims and herein for interpreting the scope of the invention.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows an example of a crosslinking reaction of polyethyleneimine (PEI) and diglycidyl ether (GDE) and the CO₂ absorption by PEI-GDE microgels according to one embodiment of the present disclosure.

FIG. 2 shows an example crosslinking reaction of PEI and tetrakis (hydroxypropyl) phosphonium chloride (THPC) and carbamate formation upon CO₂ adsorption according to one embodiment of the present disclosure.

FIG. 3 shows an example crosslinking reaction of PEI and phosphonitrillic chloride (PNC) and carbamate formation upon CO₂ adsorption according to one embodiment of the present disclosure.

FIG. 4 shows porous composite structures for CO₂ absorption based on L-PEI cryogel according to one embodiment of the present disclosure.

FIG. 5 shows a schematic diagram of a L-PEI microgels@cryogel composite according to one embodiment of the present disclosure.

FIG. 6 shows in situ metal nanoparticle preparation in L-PEI cryogel composites according to one embodiment of the present disclosure.

FIG. 7 shows a reactive capture system to convert CO₂ to industrially generated CO₂ to useful products according to one embodiment of the present disclosure.

FIG. 8 shows a comparison of CO₂ adsorption ability of bare, NaOH, and HCl treated (a) PEI-GDE, (b) PEI-THPC, and (c) PEI-PNC microgels according to embodiments of the present disclosure.

### DETAILED DESCRIPTION

Disclosed herein are transiently porous PEI based composite structures for CO₂ capture that can transform CO₂ into useful chemical products. These transiently porous PEI based composite structures are based on polyethyleneimine (L-PEI) and have gradually lessening porosity. Further disclosed herein is the synthesis of a porous linear (L)-polyethylene imine (PEI) cryogel-based composite which can adsorb CO₂. Metal nanoparticles (MNP) catalysts such as Ru, Cu, and Ni can be prepared within the superporous L-PEI cryogels composite. The superporous L-PEI can be embedded with a variety of active components including graphene, graphene oxide and reduced graphene oxide, carbon nanotubes (single-walled carbon nanotube, multiwalled nanotubes), PEI-modified carbon nanotubes, porous carbon particles (p-CP), MXenes and modified MXenes, kaolin, bentonite (montmorillonites), halloysite nanotubes, calcium II (Ca(II)) ions, magnesium ions (Mg(II)), aluminum ions (Al(III)) containing PEI microgels/nanogels, covalent organic frameworks (COFs), silicate particles and their amine modified forms, and combinations thereof. The embedded components assist CO₂ capture by adsorbing CO₂, absorbing CO₂, or otherwise associating with CO₂. In some instances, the embedded components are reactive towards CO₂.

The superporous L-PEI materials can capture carbon dioxide (CO₂) from the air or from waste streams such as chimneys of factories, and power stations using natural gas, coal, or other relevant industries. The metal-containing superporous L-PEI cryogels composite can capture CO₂ and convert it to valuable products such as methanol, ethanol, carbonic acid, and methane with the flowing of suitable gas such as oxygen, hydrogen, air, water, or a combination of gases.

As used herein, “superporous” refers to the presence of interconnected microscopic pores in a material. The pore size can range from 50 nanometers to 500 micrometers.

As used herein “transient porosity” means the material has changeable porosity. For example, the pore size can be determined during the synthesis. Additionally, and alternatively, the pore sizes can change depending on the medium. In one example, the pore size can change depending on the solvent, such as water or alcohol. In another example, the pore size can change depending on the pH. In yet another example, the pore size can change depending on the presence of salts, type of salt, or concentration of salt.

As used herein, a microgel is a colloidal gel that includes particles that are chemically crosslinked three-dimensional polymer networks. Microgels can swell or shrink in response to external stimuli such as temperature, pH, ionic strength, electric field, and enzyme activities.

As used herein, a nanogel is a three-dimensional gel material in the nanoscale size range. Nanogels can be formed by crosslinked swellable polymer networks.

As used herein, a cryogel is a polymer gel formed under frozen or semi-frozen conditions, where a polymer network forms around ice crystals. The polymer network formation may include a crosslinker. Subsequent thawing of ice crystals results in a polymeric material having an interconnected porous network.

As used herein, the term “associated” describes the interaction between two atoms, molecules, biological structures, and combinations thereof. In some embodiments, this interaction can include physical or chemical interactions, or combinations of physical and chemical interactions. Physical interactions can include adsorption, absorption, intermolecular interactions, intramolecular interactions, van der Waals forces, electrostatic interactions, dipolar interactions, dipole-dipole interactions, dipole-induced dipole interactions, charge-dipole interactions, hydrogen bonding, magnetic dipole-dipole interactions, ligand interactions, coordination complexes, or entrapment. Chemical interactions can include covalent bonding, ionic bonding, indirect bonding (i.e., an atom or group of atoms that chemically links the two atoms, molecules, or biological structures together).

Disclosed herein is a superporous material formed from polyethyleneimine gels (PEI) for the adsorption of CO₂, where the superporous material can include an embedded body. The PEI gel can be formed from linear polyethyleneimine (L-PEI) or branched polyethyleneimine (B-PEI), or a combination thereof. In some aspects, the superporous material can be a microgel. In other aspects, the superporous material can be a cryogel.

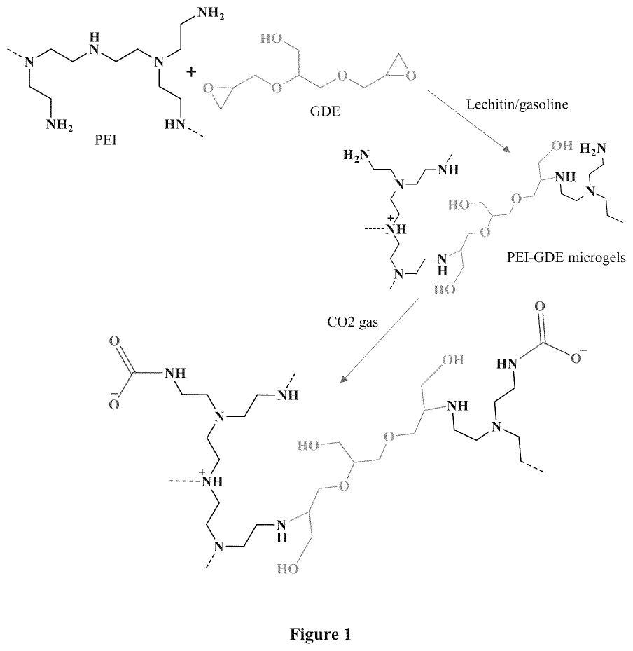

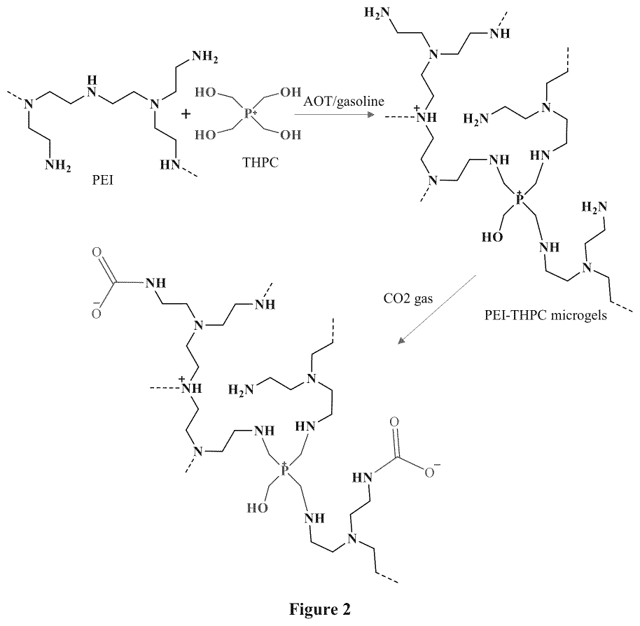

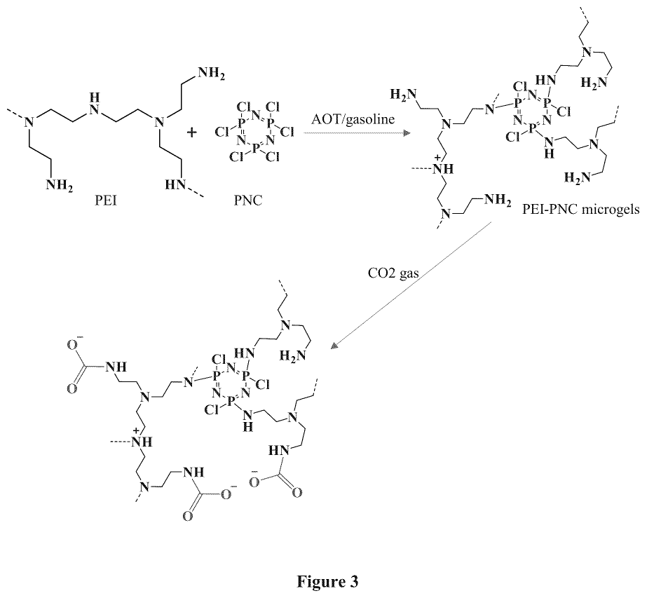

According to an aspect as disclosed herein, the superporous material is the reaction product of PEI with a crosslinker as shown in FIGS. 1-3. The crosslinker can be glycerol diglycidyl ether (GDE, FIG. 1), tetrakis (hydroxypropyl) phosphonium chloride (THPC, FIG. 2), phosphonitrillic chloride (PNC, FIG. 3). Additionally, and alternatively, divinyl sulfone (DVS) can be used as the crosslinker. The PEI gel includes free amine functional groups that react with CO₂ to form a carbamate as shown in FIGS. 1-3.

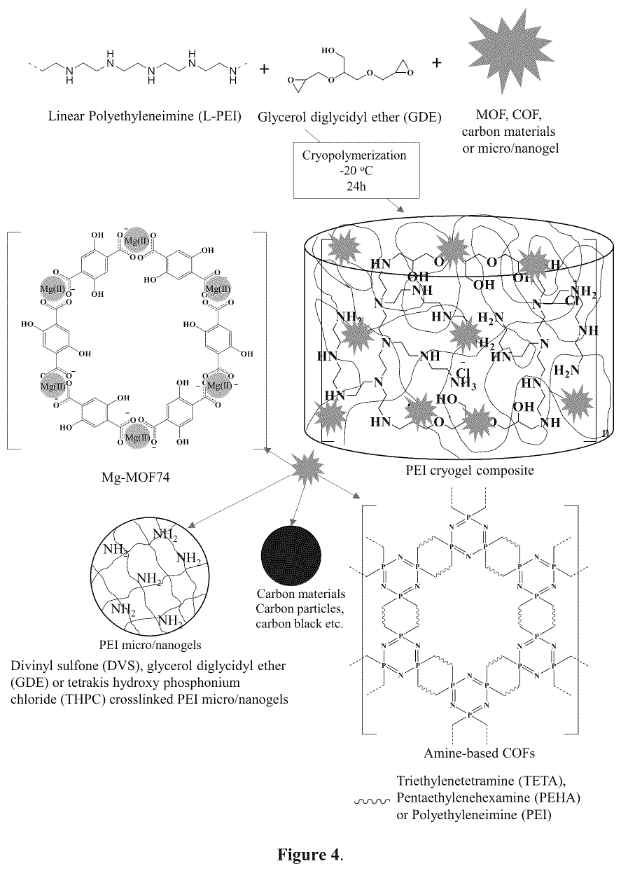

In some aspects, the superporous material can include an embedded body as shown in FIG. 4. The embedded body can be any material capable of CO₂ association. For example, the embedded body can be a material that adsorbs CO₂, absorbs CO₂, or otherwise reacts with and captures CO₂. The embedded body can be any adsorbent material, absorbent material, or a material known for reactive capture of CO₂ such as a catalyst.

According to as aspect as disclosed herein, the embedded body can be a microgel particle, for example a PEI microgel. Additionally, and alternatively, the embedded body can be a nanogel particle, for example a PEI nanogel. In further aspects, the embedded body can be a cryogel particle, for example a PEI cryogel.

In some aspects, the embedded body can be a framework material. For example, the framework material can be a covalent organic framework (COF). More specifically, the framework material can be an amine-based COF, for example a COF consisting of PNC crosslinked triethylenetetramine (TETA), pentaethylenchexamine (PEHA), or PEI, as shown in FIG. 4.

In other aspects, the framework material can be a metal organic framework (MOF). In some examples, the MOF can contain —OH and —NH₂ groups. In other examples, the framework material can be a zeolitic imidazolate framework (ZIF). In a specific example, the framework material can be Mg-MOF74.

In still further aspects, the embedded body can be a carbon material. The carbon material can be porous carbon particles (p-CP). The carbon material can be carbon black. The carbon material can be carbon nanotubes, including single-walled nanotubes or multiwalled carbon nanotubes. The carbon material can be graphene, including graphene oxide and reduced graphene oxide. In some examples, the embedded body can be a carbon material having at least one amine functional group. For example, the embedded body can be PEI-modified carbon nanotubes.

In some aspects, the embedded body can be a clay. For example, the clay can be kaolin, bentonite, montmorillonite, or halloysite nanotubes. In some examples, the embedded body can be a clay having at least one amine functional group. In other examples, the embedded body can be a silicate particle.

In some aspects, the embedded body can be a silicate particle. In other aspects, the embedded body can be a silicate particle having at least one amine functional group.

In some aspects, the embedded body can be a MXene. In other examples, the embedded body can be a modified MXene. In further examples, the embedded body can be a modified MXene having at least one amine functional group.

In some aspects, the embedded body can include a metal ion. For example, the metal ion can be a calcium ion, a magnesium ion, or an aluminum ion. In other examples, the metal ion can be a copper ion, a nickel ion, a cobalt ion, an iron ion, a ruthenium ion, a palladium ion, a platinum ion, an osmium ion, an iridium ion, or a rhodium ion. In some examples, the embedded body is a metal oxide, for example magnesium oxide (MgO) or calcium oxide (CaO).

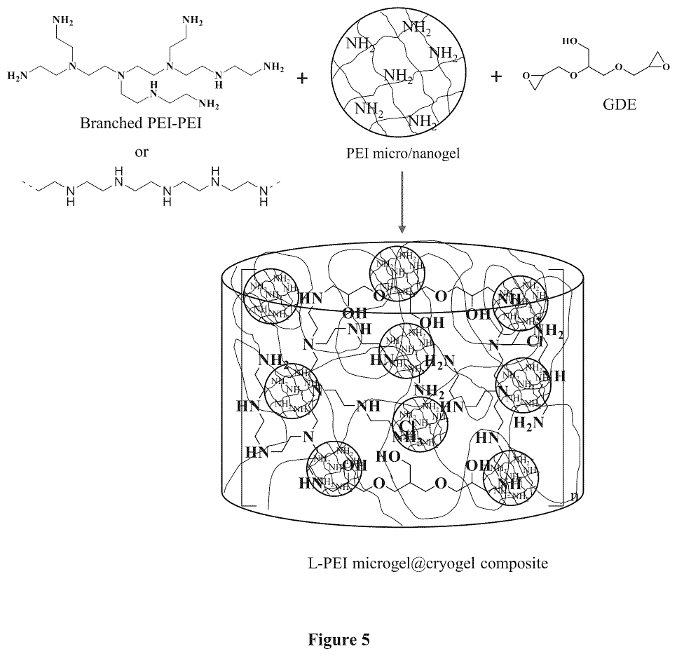

According to a method as disclosed herein, a superporous material with an embedded body can be formed by cryopolymerization, or crosslinking PEI in the presence of the embedded body at low temperatures as shown in FIG. 4. In certain aspects, the superporous material be a composite, where PEI microgel particles are embedded within a PEI cryogel as shown in FIG. 5. In this example, B-PEI or L-PEI can be combined with PEI microgel particles or PEI nanogel particles and GDE where crosslinking results in the formation of a microgel@cryogel composite.

In certain aspects, superporous material is a cryogel. The cryogel can be formed from a PEI gel according to the following steps. First, a solution of PEI and embedded body is prepared to form a mixture. Optionally, the PEI solution is heated before a crosslinker is added. For example, the PEI solution can be heated at room temperature to 50° C., 60° C., 70° C., 80° C., or 100° C., where room temperature is between 20° C. and 25° C. The embedded body can be added to the PEI solution preferably before the crosslinker is added. The mixture is then frozen and stored at a temperature between −10° C. and −80° C. for between 12 hours and 48 hours. For example, the mixture can be cooled, frozen, and stored at −18° C. or −20° C. for 24 hours. In some examples, the mixture is placed in a shaping mold, such as a straw, before freezing. The shaping mold can be in the form of a cylinder, cube, sphere, disk, torus, or any desired shape. Next, the mixture is thawed and warmed to room temperature. As a last step, the mixture is freeze-dried to form the superporous material as a cryogel.

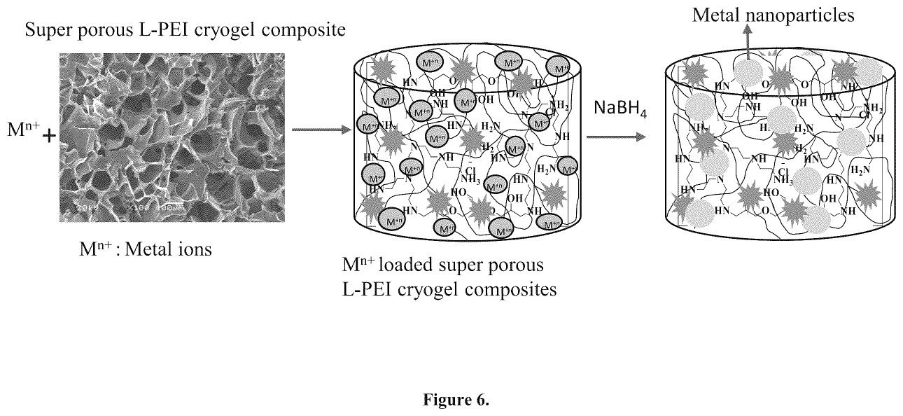

According to a method as disclosed herein, a catalytic superporous material can be prepared as shown in FIG. 6. The method of preparing a catalytic superporous material can include a first step of providing a superporous material with an embedded body, where the embedded body acts as a template for forming a metal catalyst. In this case, the embedded body can be a metal organic framework or a covalent organic framework. In a second step, the superporous material is loaded with metal ions by immersion of the superporous material in a solution of at least one metal ion. Optionally, the superporous material is immersed in more than one solution of metal ions. The solution of metal ions can include Cu(II), Ru(III), Co(II), Ni(II), or combinations thereof. The embedded body interacts with the metal ions as a template. In a third step, the loaded superporous material is treated with aqueous NaBH₄ solution to reduce the metal ions to form metal catalyst particles embedded within the catalytic superporous material.

According to a method as disclosed herein, a superporous material having an embedded body can be used to capture CO₂ from a waste stream. It is contemplated that the superporous material can be contacted with a fluidic waste stream containing CO₂. The CO₂ from the fluidic waste stream bonds to an amine functional group in the superporous material as shown in FIGS. 1-3 to form a carbamate. In one aspect, the amine functional group can be integral with the superporous material. In another aspect, the amine functional group can be integral with the embedded body. Optionally the superporous material can be treated with a base prior to contacting the waste stream.

Additionally, and alternatively, a catalytic superporous material can be used in a reactive capture system to remove CO₂ from a fluidic waste stream by capturing the CO₂ and then transforming CO₂ by chemical reaction. In a first step, the catalytic superporous material can be contacted with the fluidic waste stream. In this step, CO₂ adsorbs to the catalytic superporous material by forming a carbamate with any free amine functional groups. In a second step, the superporous material can be contacted with a flowing gas. The flowing gas can be H₂, O₂, air, or water. The waste stream and the flowing gas can optionally contact the catalytic superporous material at the same time. In a third step, the adsorbed CO₂ reacts with the flowing gas such as H₂, air and mixtures of these gases to form at least one of methanol, ethanol, carbonic acid, and methane.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed clement as essential to the practice of the invention.

All references, including publications, patent applications, and patents, cited herein are hereby incorporated by reference to the same extent as if cach reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

Reactive Capture Approaches that Convert Industrially Produced CO₂ to Useful Products On-Site: To convert the captured CO₂ into methanol and useful products.

For these purposes, metal nanoparticles (MNP) such Ru, Cu, Ni and so on are prepared within the L-PEI cryogels. The inventors have extensive expertise in situ metal nanoparticle preparation within hydrogel, cryogels, and micro/nanogels [Ref. 23], and Table 1 summarizes some of the metal nanoparticle that are used in preparation some chemical products from CO₂.

TABLE 1
The catalysts used in fuels from CO₂.

| CO₂ based fuels | Catalyst |
|---|---|
| Methane | Pd, Ru, Pt, Rh meta nanoparticle doped ZrO₂, |
| | SiO₂, Al₂O₃, CeO₂, TiO₂ |
| Methanol | Cu/γ-Al₂O₃, |
| | Cu—Zn—Zr (C₆Z¹₃Z²₁, C₄Z¹₂Z²₂, C₃Z¹₃Z²₃) |
| | composites |
| | where Z¹, Z² can each be Zn or Zr |
| Synthetic gasoline | Pd, Ru, Pt, Rh, Ni doped MgO/SiO₂, |
| | Co, Ru, Ir, Pt, Ni, Rh doped Al₂O₃, |
| | Ru, Rh, Pt doped spinel |

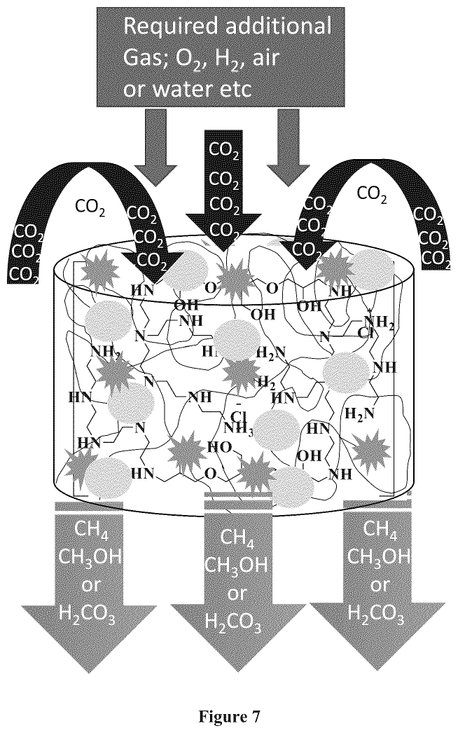

In this invention several adsorbents having susceptibility for CO₂ adsorption and absorption will be embedded within the superporous L-PEI gels. As the materials such as r-GO, m-CNT, m-HNT, porous Carbon particles, MOF, COFs, and clays will be suspended in the L-PEI solution before cryogellation, the obtained structure will be composites. The schema given in FIG. 7 demonstrates the preparation of superporous L-PEI containing some non-polymeric materials that are also commonly used in CO₂ adsorption. However, to prevent precipitation of these materials and make cryogel composites homogenous, r-GO, m-CNT, m-HNT and porous carbon particle will be also modified with L-PEI matrices. As shown in FIG. 5, L-PEI microgels are porous similar to MOF and COF, their corresponding composite structure with L-PEI can be considered as interpenetrating composite structures. These kinds of structures can be considered as mechanically tough materials.

Upon the preparation of L-PEI based superporous cryogel matrix, metal nanoparticles (MNP) that are used in the catalytic conversion of CO₂, will be prepared within the L-PEI cryogels in situ by the reduction of the metal ions loaded inside L-PEI cryogels via NaBH₄ reduction. FIG. 6 demonstrates the in-situ metal nanoparticle preparation within L-PEI cryogel composites. The super porous L-PEI cryogel will be loaded with metal ions such as Cu(II), Ru(III), Co(II), Ni(II) or so from the corresponding metal salt solution by simply immersion of the L-PEI cryogels to the corresponding metal ion solutions. After the metal ion loading within the super network of L-PEI cryogel, these cryogels will be treated with aqueous NaBH₄ solution to reduce the M(II) or M(III) ions to the corresponding metal nano particles (MNP). These MNP particles can be prepared form one type of metal ion or two types of metal ions. For example, the metal ions can be loaded into cryogels individually, simultaneously, or sequentially to obtain the desired MNP catalysts to be used to covert CO₂ to methane (CH₄) or methanol (CH₃OH) or other types of chemicals.

After the preparation of super porous L-PEI cryogel composites for CO₂ adsorbing materials, the system will be used as reactor for conversion of CO₂ as Reactive Capture and then convert to the useful product on-site. FIG. 7 depicts the system that is used in the invention.

Primary amine groups form carbamates after reaction with CO₂ at low temperature according to reaction (1):

CO₂+2R—NH₂↔R—NH₃+R—NH—COO— (1)

### Experimental

### 1. Synthesis of Linear-Polyethyleneimine (L-PEI) Chains

The synthesis of L-PEI is done by following literature [Ref. 24]. In short, 10 g of poly (2-ethyl-2-oxazoline) is dissolved in 10 mL of 18% (w/w) hydrochloric acid and then refluxed at 100° C. for 14 hours. Then, the obtained blurry solution was added onto 500 mL of ice-cold water. Next, 4 M NaOH solution is added onto ice-cold water up to pH 11. The obtained precipitate is the base form of L-PEI and can be collected by centrifugation at 10000 rpm for 10 minutes. Finally, the prepared L-PEI chains is washed with ice-cold water for twice and dried in freeze-dryer. The washed and dried white color L-PEI chains were stored in closed tubes for further usage.

### 2. Synthesis of Linear-Polyethyleneimine (L-PEI) Microgels

The synthesis of L-PEI microgels is carried out by earlier reported studies by our group [Ref. 25]. In brief, 0.3 g of L-PEI is dissolved in 5 mL of water at 100° C. Then, this solution is added to 300 mL of Lecithin/gasoline solution, which is mixed (approximately 20 minutes) in an oil bath adjusted to 60° C. until the temperature balance is homogeneous. After that, a certain amount of GDE crosslinker (10, 25, and 50 mol % of repeating unit of L-PEI (—CH₂—CH₂—NH—, 43 g/mol)) is added and stirring continued at 1500 rpm for 12 hours more. After that, the formed PEI microgels are washed in 30 mL gasoline three times, then washed with ethanol, ethanol-water (1:1), water-acetone (1:1) and acetone respectively by centrifuging at 10000 rpm for 5 minutes each time, and dried with a heat gun. Finally, the synthesized, washed, and dried L-PEI microgels are stored in a closed tube for characterization and further studies.

### 3. Synthesis of Linear-Polyethyleneimine (L-PEI) Cryogels

The synthesis of L-PEI cryogels are carried out in two different ways by following literature with some modifications [Ref. 25]. In the first way, the L-PEI cryogels is carried out by freezing/thawing method [Ref. 24]. In short, 0.5 g of L-PEI is dissolved in 8 mL of water at 100° C., and the dissolved L-PEI solution at 6.25% w/w concentration is placed into plastic straws (˜8 mm diameter), then quickly placed into a deep freezer at −18° C. for 24 hours for freezing process. Then, the frozen L-PEI solution is thawed to room temperature and cut to similar sizes of about 0.5 cm, washed with DI water 5 times via changing water every 2 hours and dried in freeze-dryer.

In the second way, the L-PEI cryogels are synthesized by using a cryocrosslinking technique [Ref. 25]. For this purpose, 10 mL of L-PEI solution (5% w/w in water) is prepared at 100° C. into a vial. Then, the GDE crosslinker (1, 2.5, and 5 mol % based on the repeating unit of L-PEI ((—CH₂—CH₂—NH—, 43 g/mol)) added to L-PEI solution under continuous stirring at 500 rpm at 100° C., and quickly placed into plastic straws (−8 mm diameter), then quickly placed into a deep freezer at −20° C. for 24 hours to complete cryocrosslinking. After that, the prepared L-PEI cryogels are cut to similar sizes of about 0.5 cm, washed with DI water 5 times via changing water every 2 hours and dried in freeze-dryer. The synthesized, washed, and dried L-PEI cryogels are stored in a closed zip lock bag for characterization and studies.

### 4. PEI-GDE Microgels

For polyethyleneimine (PEI, 50% in water, Mn: 1800, Sigma Aldrich) microgel synthesis, the reported method was followed with some modifications [Ref. 26]. Briefly, a certain amount of PEI solution (10 mL, 50% in water) is placed in 300 mL 0.1 M lecithin/gasoline solution in a 500 mL flask and stirred at 1500 rpm for about 2 hours. Then, a certain amount of glyceroldiglycidyl ether (GDE, technical grade, Sigma Aldrich) crosslinker (50 mol % of repeating unit of PEI) was added and stirring continued at 1500 rpm for 2 hours more. After that, the formed PEI-GDE microgels are washed in 100 mL cyclohexane, then will be washed with ethanol, ethanol-water (1:1), water-acetone (1:1) and acetone respectively by centrifuging at 24,700 g for 5 minutes each time and dried with a heat gun. Finally, the synthesized, washed, and dried PEI-GDE microgels are stored in a closed tube for characterization and further studies.

### 5. PEI-THPC Microgels

The tetrakis (hydroxypropyl) phosphonium chloride (THPC, 80% in water, Sigma Aldrich) crosslinked PEI microgel synthesis is carried out with the following reported method with some modifications [Ref. 26]. Briefly, a certain amount of PEI solution (1 mL, 50% in water) was placed in 30 mL 0.1 M AOT/gasoline solution in a 30 mL vial and stirred at 1000 rpm for about 30 minutes. Then, a certain amount of THPC crosslinker (100 mol % of repeating unit of PEI) is added and stirring continued at 1000 rpm for 30 minutes more. After that, the formed PEI-THPC microgels are precipitated in excess amount of acetone and washed with ethanol, ethanol-water (1:1), water-acetone (1:1) and acetone respectively by centrifuging at 24,700 g for 5 minutes each time and dried with a heat gun. Finally, the synthesized, washed, and dried PEI-THPC microgels are stored in a closed tube for characterization and further studies.

### 6. PEI-PNC Microgels

The phosphonitrillic chloride (PNC, 99%, Sigma Aldrich) crosslinked PEI microgel synthesis is carried out with the following reported method with some modifications [Ref. 26]. Briefly, a certain amount of PEI solution (1 mL, 50% in water) is placed in 25 mL 0.1 M AOT/gasoline solution in a 30 mL vial and stirred at 1000 rpm for about 30 minutes. Then, a certain amount of PNC crosslinker (100 mol % of repeating unit of PEI) is dissolved in 5 mL of 0.1 M AOT/gasoline solution and added to PEI contain vial and stirring continued at 1000 rpm for 1 hour more. After that, the formed PEI-PNC microgels are precipitated in excess amount of acetone and washed with ethanol, ethanol-water (1:1), water-acetone (1:1) and acetone respectively by centrifuging at 24,700 g for 5 minutes each time and dried with a heat gun. Finally, the synthesized, washed, and dried PEI-PNC microgels are stored in a closed tube for characterization and further studies.

The possible structures of CO₂ adsorbed PEI-GDE, PEI-THPC, and PEI-PNC microgels are given in FIG. 1, FIG. 2, and FIG. 3, respectively.

### 7. Acid/Base Treatment of PEI Based Microgels

For the sodium hydroxide (NaOH, 99%, WVR chemicals) and hydrochloric acid (HCl, 36.5%, WVR chemicals) are also used for the NaOH and HCl treatment of 0.5 g of PEI based microgels in 50 mL of 1 M aqueous solutions of NaOH and HCl, separately.

### CO₂ Adsorption With PEI Based Microgels

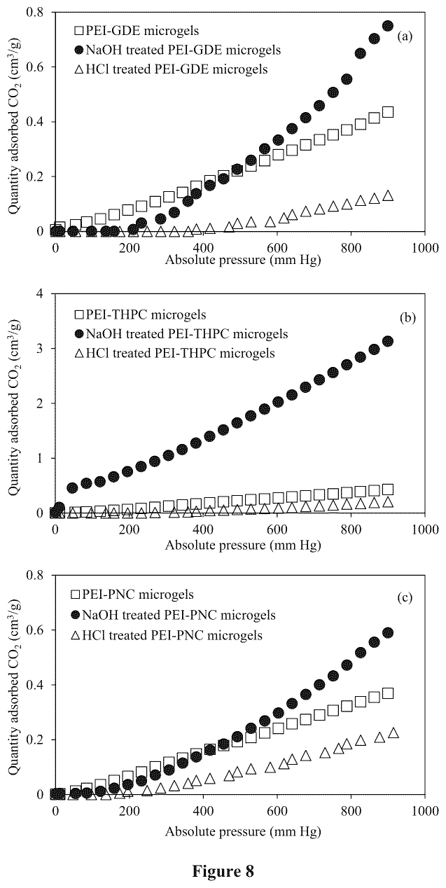

Amine groups have an affinity for acidic CO₂ through the formation of ammonium carbamate species under anhydrous condition. In here the potential utilization of prepared PEI based microgels on effective CO₂ adsorption was successfully shown. Moreover, the effects of NaOH and HCl treatment of particles on CO₂ adsorption were also investigated. The CO₂ adsorption capabilities of PEI based microgels were determined with a CO₂ gas tube attached surface area and porosity device (Micromeritics, TriStar III). For this purpose, the washed and dried PEI based microgels were degassed under N₂ gas before CO₂ adsorption studies. The obtained graphs are shown in FIG. 8 and the adsorbed CO₂ amount with PEI-based microgels are given in Table 2.

In FIG. 5 (a), the CO₂ gas adsorption of PEI-GDE based microgels are compared to each other. It was clearly seen that, the CO₂ gas adsorption ability of PEI-GDE microgels increased after NaOH treatment, whereas decreased after HCl treatment, respectively. The adsorbed amount of CO₂ with PEI-GDE, NaOH treated PEI-GDE, and HCl treated PEI-GDE microgels at approximately 760 mmHg pressure.

The adsorbed amount of CO₂ on PEI-THPC, NaOH treated PEI-THPC, and HCl treated PEI-THPC microgels were also compared in FIG. 5 (b). It was observed that, the PEI-THPC, NaOH treated PEI-THPC, and HCl treated PEI-THPC microgels adsorbed CO₂ at approximately 760 mm Hg pressure, respectively. At 900 mm Hg pressure, CO₂ adsorption was observed for PEI-THPC, NaOH treated PEI-THPC, and HCl treated PEI-THPC microgels, respectively.

The CO₂ adsorption graph of PEI-PNC, NaOH treated PEI-PNC and HCl treated PEI-PNC microgels was also given in FIG. 8, and it was clearly seen that PEI-PNC, NaOH treated PEI-PNC and HCl treated PEI-PNC microgels adsorbed CO₂ at approximately 760 mm Hg, respectively. On the other hand, at 900 mm Hg pressure, CO₂ adsorption were observed for PEI-PNC, NaOH treated PEI-PNC and HCl treated PEI-PNC microgels, respectively.

Moreover, the adsorbed amount of mmol CO₂ with PEI based microgels were calculated from the density of CO₂ and summarized in Table 1. It can be clearly seen that higher amounts of CO₂ adsorption were observed for NaOH treated PEI microgels with CO₂ for NaOH treated PEI-GDE, PEI-THPC, and PEI-PNC microgels, respectively.

TABLE 2
The comparison of adsorbed CO₂ amount (mmol/g) with
PEI based microgels as measured in this study.

| | Temperature | Pressure | Adsorbed CO₂ |
|---|---|---|---|
| Adsorbent | (° C.) | (atm) | (mmol/g) |
| PEI-GDE | 25 | 1.2 | 0.021 |
| PEI-GDE NaOH | 25 | 1.2 | 0.036 |
| PEI-THPC | 25 | 1.2 | 0.021 |
| PEI-THPC NaOH | 25 | 1.2 | 0.152 |
| PEI-PNC | 25 | 1.2 | 0.018 |
| PEI-PNC NaOH | 25 | 1.2 | 0.028 |
| L-PEI-GDE (%10X) | 25 | 1.2 | 0.062 |
| L-PEI-GDE (%10X) NaOH | 25 | 1.2 | 0.065 |
| L-PEI-GDE (%25X) | 25 | 1.2 | 0.047 |
| L-PEI-GDE (%25X) NaOH | 25 | 1.2 | 0.093 |
| L-PEI-GDE (%50X) | 25 | 1.2 | 0.033 |
| L-PEI-GDE (%50X) NaOH | 25 | 1.2 | 0.114 |
| HNT | 25 | 1.2 | 0.056 |
| HNT-PEI | 25 | 1.2 | 0.122 |
| HNT-PEI-NaOH | 25 | 1.2 | 0.303 |
| ZIF-8 | 25 | 1.2 | 1.086 |
| ZIF-67 | 25 | 1.2 | 1.068 |
| Graphene aerogels | 25 | 1.2 | 0.323 |
| Carbon particles | 25 | 1.2 | 2.247 |
| PTCDA-PEI | 25 | 1.2 | 0.395 |
| PTCDA-PEHA | 25 | 1.2 | 0.321 |
| PTCDA-TAEA | 25 | 1.2 | 0.297 |

### REFERENCES

1. Kupper, T., et al., Ammonia and greenhouse gas emissions from slurry storage-A review. Agriculture, ecosystems & environment, 2020. 300: p. 106963.
2. Tejedor, E., et al., Global hydroclimatic response to tropical volcanic eruptions over the last millennium. Proceedings of the National Academy of Sciences, 2021. 118(12): p. e2019145118.
3. Huybers, P. and C. Wunsch, Obliquity pacing of the late Pleistocene glacial terminations. Nature, 2005. 434(7032): p. 491-494.
4. Choi, W., et al., Epoxide-functionalization of polyethyleneimine for synthesis of stable carbon dioxide adsorbent in temperature swing adsorption. Nature communications, 2016. 7(1): p. 1-8.
5. Cui, H., et al., Isoreticular microporous metal-organic frameworks for carbon dioxide capture. Inorganic chemistry, 2020. 59(23): p. 17143-17148.
6. Varghese, A. M. and G. N. Karanikolos, CO₂ capture adsorbents functionalized by amine-bearing polymers: A review. International Journal of Greenhouse Gas Control, 2020. 96: p. 103005.
7. Choi, W., et al., Structural effects of amine polymers on stability and energy efficiency of adsorbents in post-combustion CO₂ capture. Chemical Engineering Journal, 2021. 408: p. 127289.
8. Spigarelli, B. P. and S. K. Kawatra, Opportunities and challenges in carbon dioxide capture. Journal of CO₂ Utilization, 2013. 1: p. 69-87.
9. Piscopo, C. G. and S. Loebbecke, Strategies to Enhance Carbon Dioxide Capture in Metal-Organic Frameworks. ChemPlusChem, 2020. 85(3): p. 538-547.
10. Mukherjee, A., et al., Review of post-combustion carbon dioxide capture technologies using activated carbon. Journal of Environmental Sciences, 2019. 83: p. 46-63.
11. Maniarasu, R., S. K. Rathore, and S. Murugan, A review on materials and processes for carbon dioxide separation and capture. Energy & Environment, 2021: p. 0958305X211050984.
12. Weir, B., et al., Regional impacts of COVID-19 on carbon dioxide detected worldwide from space. Science advances, 2021. 7(45): p. eabf9415.
13. Ricke, K. L. and K. Caldeira, Natural climate variability and future climate policy. Nature Climate Change, 2014. 4(5): p. 333-338.
14. Gao, W., et al., Industrial carbon dioxide capture and utilization: state of the art and future challenges. Chemical Society Reviews, 2020. 49(23): p. 8584-8686.
15. D'Alessandro, D. M., B. Smit, and J. R. Long, Carbon dioxide capture: prospects for new materials. Angewandte Chemie International Edition, 2010. 49(35): p. 6058-6082.
16. Hussin, F. and M. K. Aroua, Recent trends in the development of adsorption technologies for carbon dioxide capture: A brief literature and patent reviews (2014-2018). Journal of Cleaner Production, 2020. 253: p. 119707.
17. Pires, J., et al., Recent developments on carbon capture and storage: An overview. Chemical engineering research and design, 2011. 89(9): p. 1446-1460.
18. Bilanovic, D., et al., Freshwater and marine microalgae sequestering of CO₂ at different C and N concentrations-response surface methodology analysis. Energy Conversion and Management, 2009. 50(2): p. 262-267.
19. Skjånes, K., P. Lindblad, and J. Muller, BioCO2—A multidisciplinary, biological approach using solar energy to capture CO2 while producing H2 and high value products. Biomolecular engineering, 2007. 24(4): p. 405-413.
20. Stewart, C. and M. -A. Hessami, A study of methods of carbon dioxide capture and sequestration—the sustainability of a photosynthetic bioreactor approach. Energy Conversion and management, 2005. 46(3): p. 403-420.
21. Bode, S. and M. Jung, Carbon dioxide capture and storage—liability for non-permanence under the UNFCCC. International Environmental Agreements: Politics, Law and Economics, 2006. 6(2): p. 173-186.
22. Solomon, S., M. Carpenter, and T. A. Flach, Intermediate storage of carbon dioxide in geological formations: a technical perspective. International journal of greenhouse gas control, 2008. 2(4): p. 502-510.
23. Sahiner N. Soft and flexible hydrogel templates of different sizes and various functionalities for metal nanoparticle preparation and their use in catalysis. Progress in Polymer Science, 2013, 38 (9), 1329-1356
24. Soradech, S.; Williams, A. C.; Khutoryanskiy, V. V. Physically Cross-Linked Cryogels of Linear Polyethyleneimine: Influence of Cooling Temperature and Solvent Composition, Macromolecules, 2022, 55, 9537-9546, doi:10.1021/acs.macromol.2c01308.
25. Sahiner N., Demirci S., PEI-based hydrogels with different morphology and sizes: Bulkgel, microgel, and cryogel for catalytic energy and environmental catalytic applications, Eur. Polym. J., 2016, 76, 156-169. https://doi.org/10.1016/j.eurpolymj.2016.01.046.
26. Demirci S., Sahiner N., PEI-based ionic liquid colloids for versatile use: Biomedical and environmental applications. J Mol Liq. 2014, 194:85-92. https://doi.org/10.1016/j.molliq.2014.01.015

The citation of any document is not to be construed as an admission that it is prior art with respect to the present invention.

Thus, the invention provides a superporous material comprising: a crosslinked linear polyethyleneimine (PEI) microgel comprising the reaction product of linear polyethyleneimine and a crosslinker; an embedded body; and amine functional groups, wherein the embedded body and amine functional groups are available for CO₂ association. There is also provided a method of removing CO₂ from a fluidic waste stream, wherein the method comprises contacting the waste stream with the superporous material, wherein the CO₂ from the fluidic waste stream bonds to an amine functional group in the superporous material. There is also provided a method of removing CO₂ from a fluidic waste stream, wherein the method comprises contacting the waste stream with the catalytic superporous material and a flowing gas, and converting CO₂ to at least one of methanol, ethanol, carbonic acid, and methane.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment”, “in certain embodiments”, or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein. Various features and advantages of the invention are set forth in the following claims.

We claim:

1. A superporous material comprising:
a crosslinked linear polyethyleneimine (PEI) microgel comprising the reaction product of linear polyethyleneimine and a crosslinker,
an embedded body, and
amine functional groups, wherein the embedded body and amine functional groups are available for CO₂ association.

2. The superporous material of claim 1, wherein the crosslinker is selected from the group consisting of divinyl sulfone, glycerol diglycidyl ether, phosphonitrillic chloride and tetrakis hydroxyphosphonium chloride.

3. The superporous material of claim 1, wherein the embedded body comprises a PEI microgel, a PEI nanogel, a PEI cryogel, or a combination thereof.

4. The superporous material of claim 3, wherein the PEI cryogel is a crosslinked PEI cryogel.

5. The superporous material of claim 1, wherein the embedded body comprises at least one of:
a framework material selected from the group consisting of a metal organic framework (MOF), a covalent organic framework (COF), a zeolitic imidazolate framework, or a combination thereof;
a carbon material selected from the group consisting of porous carbon particles, carbon black, single-walled carbon nanotubes, multiwalled carbon nanotubes, PEI-modified carbon nanotubes, graphene, graphene oxide, reduced graphene oxide, and any combination thereof;
a metal ion selected from the group consisting of calcium ions, magnesium ions, and aluminum ions, and any combination thereof;
a clay selected from the group consisting of kaolin, bentonite, montmorillonite, halloysite nanotubes, and any combination thereof;
a silicate particle; or
a MXene or a modified MXene.

6. The superporous material of claim 5, wherein the embedded body further comprises at least one amine functional group.

7. The superporous material of claim 5, wherein the embedded body comprises an amine-based COF that is one of triethylenetetramine (TETA), pentaethylenehexamine (PEHA), or PEI crosslinked with PNC.

8. The superporous material of claim 5, wherein the embedded body comprises Mg-MOF74.

9. A method of forming a superporous material, the method comprising:
preparing a solution of PEI and an embedded body to form a mixture,
freezing the mixture,
thawing the mixture to room temperature, and
freeze-drying the mixture to form the superporous material as a cryogel.

10. The method of claim 9, further comprising:
heating the solution of PEI prior to adding a crosslinker to the solution of PEI to form the mixture.

11. The method of claim 9, wherein the mixture is frozen and kept between −18° C. and −20° C. for between 12 hours and 48 hours.

12. The method of claim 10, wherein the solution of PEI is heated at 100° C. and the mixture is cooled at −20° C. for 24 hours.

13. A method of preparing a catalytic superporous material, the method comprising:
(i) providing the superporous material of claim 1, wherein the embedded body acts as a template for forming a metal catalyst,
(ii) loading the superporous material with metal ions by immersion of the superporous material in at least one metal ion solution; and
(iii) treating the loaded superporous material from step (ii) with aqueous NaBH₄ solution to reduce the metal ions to form a metal catalyst particle embedded within the catalytic superporous material.

14. The method of claim 13, wherein the embedded body is a metal organic framework or a covalent organic framework.

15. The method of claim 14, wherein the metal ions are selected from the group consisting of Cu(II), Ru(III), Co(II), Ni(II), and combinations thereof.

16. The method of claim 13, wherein steps (ii) and (iii) are repeated using solutions of the same or different metal ions.

17. A method of removing CO₂ from a fluidic waste stream, the method comprising:
contacting the waste stream, with the superporous material of claim 1, wherein the CO₂ from the fluidic waste stream bonds to an amine functional group in the superporous material.

18. The method of claim 17, wherein the superporous material is treated with a base prior to contacting the waste stream.

19. A method of removing CO₂ from a fluidic waste stream, the method comprising:
contacting the waste stream with the catalytic superporous material of claim 1 and a flowing gas.

20. The method of claim 19, wherein the embedded body is a metal nanoparticle, and the superporous material converts CO₂ to at least one of methanol, ethanol, carbonic acid, and methane.
